(19) United States
(12) Patent Application Publication
(10) Pub. No.: US 2017/0123657 A1
(43) Pub. Date: May 4, 2017

(54) SYSTEMS AND METHODS FOR BACK UP IN SCALE-OUT STORAGE AREA NETWORK

(71) Applicant: Dell Products L.P., Round Rock, TX (US)

(72) Inventor: Govindaraja Nayaka B, Bangalore (IN)

(21) Appl. No.: 14/930,116

(22) Filed: Nov. 2, 2015

(51) Int. Cl. G06F 3/06

(52) U.S. Cl. CPC G06F 3/061; G06F 3/065; G06F 3/0619; G06F 3/067

(57) ABSTRACT

An information handling system may include a processor and a program of executable instructions embodied in non-transitory computer-readable media accessible to the processor, configured to, when read and executed by the processor: (i) communicate to a volume owner of a logical storage unit storing a snapshot to be backed up, an instruction other than an input/output read instruction for backing up the snapshot, wherein the volume owner is one of a plurality of storage nodes in a scale-out storage area network architecture communicatively coupled to the information handling system; (ii) responsive to the instruction, receive from the volume owner pages of data associated with the snapshot and metadata associated with the pages; (iii) from the metadata, form back up metadata for each page; (iv) write the pages to a back up device communicatively coupled to the information handling system; and (v) upload the back up metadata to a metadata server.

### TECHNICAL FIELD

The present disclosure relates in general to information handling systems, and more particularly to improving performance of back up operations in a scale-out storage area network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In data storage systems, users of different storage technologies store enormous amounts of data on different storage devices. With growth in the data storage industry, it is often crucial to have critical data available to applications. Often, users back up critical data periodically to different back up devices. The time taken to back up data depends on the size of a volume of logical unit (LUN) of storage, and users typically desire for back up times to be as small as possible. Traditionally, back up applications perform back ups mostly by reading a LUN's data sequentially. This approach includes the drawback that there is little ability to improved back up time, and the time to back up data increases with the size of a LUN.

### SUMMARY

In accordance with the teachings of the present disclosure, the disadvantages and problems associated with data back up in storage systems may be reduced or eliminated.

In accordance with embodiments of the present disclosure, an information handling system may include a processor and a program of executable instructions embodied in non-transitory computer-readable media accessible to the processor. The program may be configured to, when read and executed by the processor: (i) communicate to a volume owner of a logical storage unit storing a snapshot to be backed up, an instruction other than an input/output read instruction for backing up the snapshot, wherein the volume owner is one of a plurality of storage nodes in a scale-out storage area network architecture communicatively coupled to the information handling system; (ii) responsive to the instruction, receive from the volume owner pages of data associated with the snapshot and metadata associated with the pages; (iii) from the metadata, form back up metadata for each page; (iv) write the pages to a back up device communicatively coupled to the information handling system; and (v) upload the back up metadata to a metadata server.

In accordance with these and other embodiments of the present disclosure, a storage node may include a plurality of physical storage resources, a controller, and a program of executable instructions embodied in non-transitory computer-readable media accessible to the controller, and configured to, when read and executed by the controller: (i) receive from an information handling system a list of snapshots associated with logical units owned by the storage node; (ii) determine which snapshots to back up in full and which snapshots to back up incrementally as deltas to previous back ups; (iii) determine which storage nodes of a scale-out storage area network architecture are communicatively coupled to the information handling system, wherein the storage node is a member of the scale-out storage area network architecture; and (iv) communicate to each storage node having pages of snapshots to be backed up a message instructing the storage nodes other than the storage node to send pages of snapshots needing back up to the storage node.

In accordance with these and other embodiments of the present disclosure, a storage node may include a plurality of physical storage resources, a controller, and a program of executable instructions embodied in non-transitory computer-readable media accessible to the controller, and configured to, when read and executed by the controller: (i) receive from a volume owner storage node an instruction to back up data of a snapshot, wherein the storage node and the volume owner storage node are storage nodes of a scale-out storage area network architecture communicatively coupled to an information handling system; (ii) determine which pages of the snapshot reside on the storage node; (iii) receive from an information handling system a list of snapshots associated with logical units owned by the storage node; and (iv) spawn one or more threads and allocate pages of the snapshot among the threads.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system having an information handling system coupled to a scale-out storage area network, in accordance with embodiments of the present disclosure;

FIG. 2 illustrates a flow chart of an example method for backing up data from a storage array to a back up device, in accordance with embodiments of the present disclosure;

FIG. 3 illustrates a flow chart of an example method of execution of a volume owner during a back up operation, in accordance with embodiments of the present disclosure; and

FIG. 4 illustrates a flow chart of an example method of execution of a storage node having a storage resource which is part of a logical unit having stored thereon a portion of a snapshot to be backed up during a back up operation, in accordance with embodiments of the present disclosure.

### DETAILED DESCRIPTION

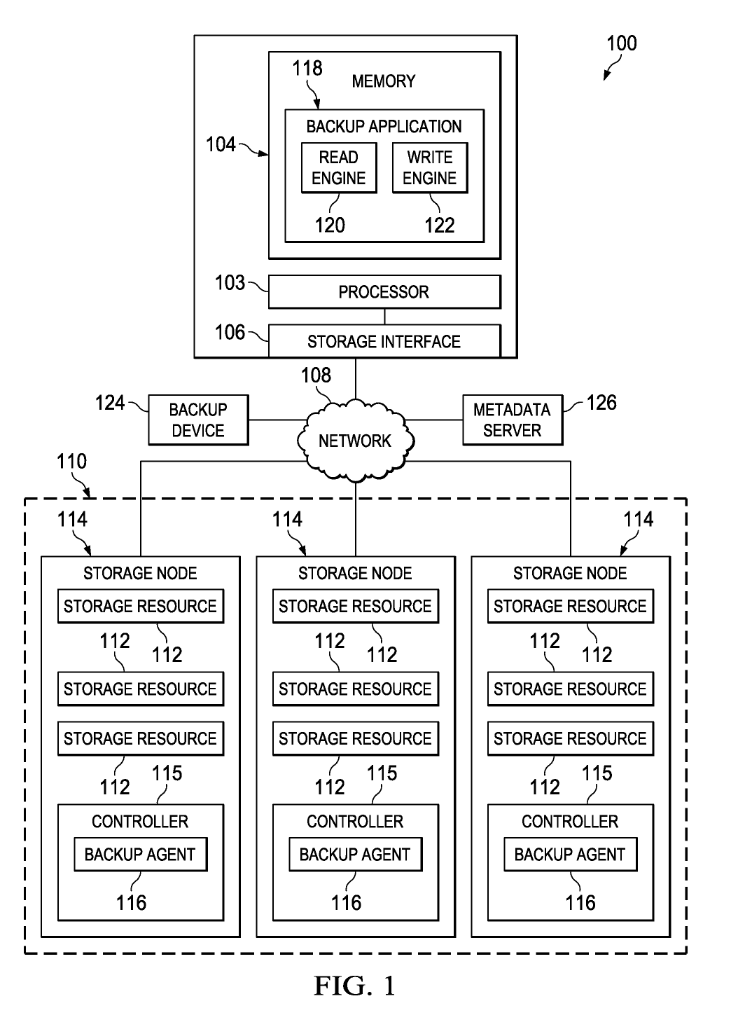

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example system 100 having a host information handling system 102, a scale-out storage area network (SAN) comprising a network 108 communicatively coupled to host information handling system 102 and a storage array 110 communicatively coupled to network 108, one or more back up devices 124, and one or more metadata servers 126, in accordance with embodiments of the present disclosure.

In some embodiments, host information handling system 102 may comprise a server. In these and other embodiments, host information handling system 102 may comprise a personal computer. In other embodiments, host information handling system 102 may be a portable computing device (e.g., a laptop, notebook, tablet, handheld, smart phone, personal digital assistant, etc.). As depicted in FIG. 1, host information handling system 102 may include a processor 103, a memory 104 communicatively coupled to processor 103, and a storage interface 106 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage media 106, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. As shown in FIG. 1, memory 104 may have a back up application 118 stored thereon.

Back up application 118 may comprise any program of executable instructions, or aggregation of programs of executable instructions, configured to, when read and executed by processor 103, manage back up operations for backing up data stored within storage array 110 to back up device 124, as described in greater detail below. Although back up application 118 is shown in FIG. 1 as stored in memory 104, in some embodiments, back up application 118 may be stored in storage media other than memory 104 accessible to processor 103 (e.g., one or more storage resources 112 of storage array 110). In such embodiments, active portions of back up application 118 may be transferred to memory 104 for execution by processor 103. As shown in FIG. 1, back up application 118 may include read engine 120 and write engine 122. As described in greater detail below, read engine 120 may read data from storage array 110 to be backed up and write engine 122 may write data to be backed up to back up device 124 and/or metadata regarding the data backed up to metadata server 126.

Storage interface 106 may be communicatively coupled to processor 103 and may include any system, device, or apparatus configured to serve as an interface between processor 103 and storage resources 112 of storage array 110 to facilitate communication of data between processor 103 and storage resources 112 in accordance with any suitable standard or protocol. In some embodiments, storage interface 106 may comprise a network interface configured to interface with storage resources 112 located remotely from information handling system 102.

In addition to processor 103, memory 104, and storage interface 106, host information handling system 102 may include one or more other information handling resources.

Network 108 may be a network and/or fabric configured to couple host information handling system 102 to storage nodes 114, back up device 124, and/or metadata server 126. In some embodiments, network 108 may include a communication infrastructure, which provides physical connections, and a management layer, which organizes the physical connections and information handling systems communicatively coupled to network 108. Network 108 may be implemented as, or may be a part of, a SAN or any other appropriate architecture or system that facilitates the communication of signals, data and/or messages (generally referred to as data). Network 108 may transmit data using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 108 and its various components may be implemented using hardware, software, or any combination thereof.

Storage array 110 may include a plurality of physical storage nodes 114 each comprising one or more storage resources 112. In some embodiments, storage array 110 may comprise a scale-out architecture, such that snapshot data associated with host information handling system 102 is distributed among multiple storage nodes 114 and across multiple storage resources 112 on each storage node 114.

Although FIG. 1 depicts storage array 110 having three storage nodes 114, storage array 110 may have any suitable number of storage nodes 114. Also, although FIG. 1 depicts each storage node 114 having three physical storage resources 112, a storage node 114 may have any suitable number of physical storage resources 112.

A storage node 114 may include a storage enclosure configured to hold and power storage resources 112. As shown in FIG. 1, each storage node 114 may include a controller 115. Controller 115 may include any system, apparatus, or device operable to manage the communication of data between host information handling system 102 and storage resources 112 of storage array 110. In certain embodiments, controller 115 may provide functionality including, without limitation, disk aggregation and redundancy (e.g., RAID), I/O routing, and error detection and recovery. Controller 115 may also have features supporting shared storage and high availability. In some embodiments, controller 115 may comprise a PowerEdge RAID Controller (PERC) manufactured by Dell Inc.

As depicted in FIG. 1, controller 115 may comprise a back up agent 116. Back up agent 116 may comprise any program of executable instructions, or aggregation of programs of executable instructions (e.g., firmware), configured to, when read and executed by controller 115, manage back up operations for backing up data stored within storage array 110 to back up device 124, as described in greater detail below. Although back up agent 116 is shown in FIG. 1 as stored within controller 115, in some embodiments, back up agent 116 may be stored in storage media other than controller 115 while being accessible to controller 115.

In some embodiments, storage nodes 114 of storage array 110 may be nodes in a storage group or storage cluster. Accordingly, in these embodiments, a particular designated storage node 114 may be a leader of such group or cluster, such that input/output (I/O) or other messages for the group or cluster may be delivered from host information handling system 102 to such leader storage node 114, and such leader storage node 114 may process such message and appropriately deliver such message to the intended target storage node 114 for the message.

In these and other embodiments, each storage node 114 may be capable of being a volume owner for a logical storage unit comprised of storage resources 112 spread across multiple storage nodes. Accordingly, in these embodiments, a storage node 114 which is a volume owner may receive messages (e.g., I/O or other messages) intended for the logical storage unit of which the storage node 114 is the volume owner, and the volume owner may process such message and appropriately deliver, store, or retrieve information associated with such message to or from a storage resource 112 of the logical storage unit in order to respond to the message.

Storage resources 112 may include hard disk drives, magnetic tape libraries, optical disk drives, magneto-optical disk drives, compact disk drives, compact disk arrays, disk array controllers, and/or any other system, apparatus or device operable to store media.

In operation, one or more storage resources 112 may appear to an operating system or virtual machine executing on information handling system 102 as a single logical storage unit or virtual storage resource 112 (which may also be referred to as a “LUN” or a “volume”). In some embodiments, storage resources 112 making up a logical storage unit may reside in different storage nodes 114.

In addition to storage resources 112 and controller 115, a storage node 114 may include one or more other information handling resources.

Back up device 124 may be coupled to host information handling system 102 via network 108, and may comprise one or more hard disk drives, magnetic tape libraries, optical disk drives, magneto-optical disk drives, compact disk drives, compact disk arrays, disk array controllers, and/or any other system, apparatus or device operable to store media. As described in greater detail below, back up device 124 may be configured to store back up data associated with storage array 110.

Metadata server 126 may be coupled to host information handling system 102 via network 108, and may comprise one or more hard disk drives, magnetic tape libraries, optical disk drives, magneto-optical disk drives, compact disk drives, compact disk arrays, disk array controllers, and/or any other system, apparatus or device operable to store media. In some embodiments, metadata server 126 may be an integral part of or otherwise co-located with back up device 124. As described in greater detail below, metadata server 126 may be configured to store metadata regarding data backed up to back up device 124.

In addition to information handling system 102, storage array 110, back up device 124, and metadata server 126, system 100 may include one or more other information handling resources.

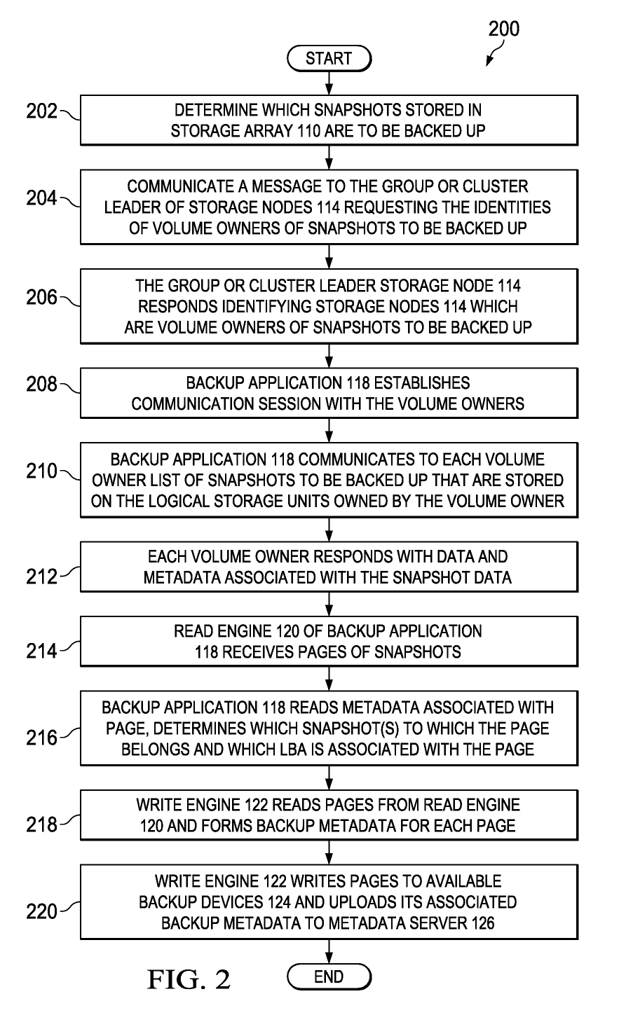

FIG. 2 illustrates a flow chart of an example method 200 for backing up data from storage array 110 to back up device 124, in accordance with embodiments of the present disclosure. According to certain embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, back up application 118 may determine which snapshots stored in storage array 110 are to be backed up. Such determination may be made based on a user command or configuration (e.g., a configuration to back up certain snapshots at regular intervals). At step 204, back up application 118 may communicate a message to the group or cluster leader of storage nodes 114 requesting the identities of the volume owners of the snapshots to be backed up.

At step 206, in response to the message communicated at step 204, the group or cluster leader of storage node 114 may respond with a message identifying the storage nodes 114 which are volume owners of the snapshots to be backed up. At step 208, in response to receiving the identities of the volume owners, back up application 118 may establish a communication session (e.g., an Internet Small Computer System Interface or “iSCSI” session) with the volume owners. At step 210, back up application 118 may communicate to each volume owner a list of snapshots to be backed up that are stored on the logical storage units owned by the volume owner, any flags associated with each snapshot (e.g., an urgent flag for prioritizing back up of some snapshots over others), and the operation type “back up.”

At step 212, each volume owner responds to the message sent at step 210 with data and metadata associated with the snapshot data, as described in greater detail below with respect to method 300. At step 214, read engine 120 of back up application 118 may receive pages of snapshots from the volume owners in an out-of-order fashion.

At step 216, when back up application 118 receives a page of data from a volume owner, it reads metadata (e.g., LUN identifier, logical block address range, etc.) associated with the page and determines which snapshot(s) to which the page belongs and which logical block address (LBA) associated with the page. At step 218, write engine 122 of back up application 118 may read pages from read engine 120 and form back up metadata for each page. Back up metadata for a page may include a LUN identifier of the page, a page number (or LBA range) of the snapshot, a unique device identifier for back up device 124 the data is backed up to, and an offset within back up device 124 in which the page of data will be stored. To determine the back up device unique identifier and offset, write engine 122 may determine a list of available allocated back up devices 124 and determine which back up devices to write to.

At step 220, write engine 122 may write pages to the available back up devices 124 and for each write of data to back up devices 124, upload its associated back up metadata to metadata server 126. After completion of step 220, method 200 may end.

Although FIG. 2 discloses a particular number of steps to be taken with respect to method 200, it may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using system 100, components thereof or any other system operable to implement method 200. In certain embodiments, method 200 may be implemented partially or fully in software (e.g., back up application) and/or firmware embodied in computer-readable media.

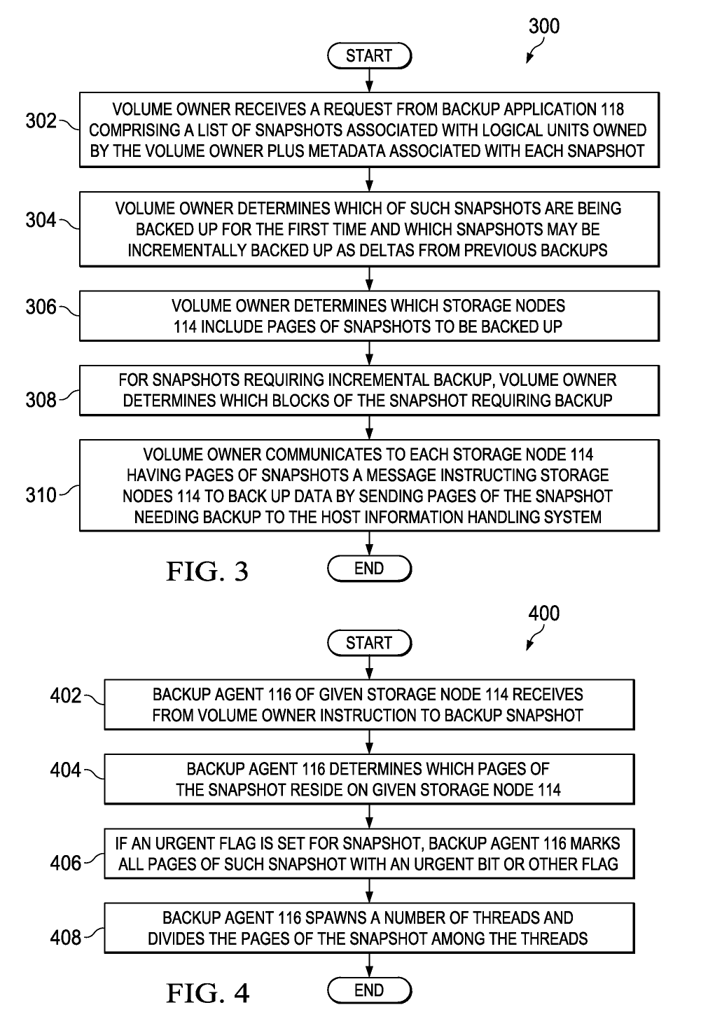

FIG. 3 illustrates a flow chart of an example method 300 of execution of a volume owner during a back up operation, in accordance with embodiments of the present disclosure. According to certain embodiments, method 300 may begin at step 302. As noted above, teachings of the present disclosure may be implemented in a variety of configurations of system 100. As such, the preferred initialization point for method 300 and the order of the steps comprising method 300 may depend on the implementation chosen.

At step 302, a volume owner may receive a request from back up application 118 comprising a list of snapshots associated with logical units owned by the volume owner plus metadata (e.g., urgent flag, operation type) associated with each snapshot. At step 304, the volume owner may determine which of such snapshots are being backed up for the first time, meaning they require full back up, and which snapshots may be incrementally backed up as deltas from previous back ups. For example, each snapshot may have metadata associated with it which is stored with the snapshot. Such metadata may include a logical unit identifier, a unique snapshot identifier, a host identifier (e.g., Internet Protocol address for a host associated with the snapshot), and a time stamp of last back up. If the time stamp is NULL or has no data, this may indicate the need for a full back up of the snapshot.

At step 306, the volume owner may determine which storage nodes 114 include pages of the snapshots to be backed up.

At step 308, for snapshots requiring incremental back up, the volume owner may determine which blocks of the snapshot require back up. For example, the volume owner may maintain a per-snapshot bitmap which tracks the blocks which have changed since the last back up of a snapshot, and may determine from each per-snapshot bitmap which blocks require back up.

At step 310, the volume owner may communicate to each storage node 114 having pages of the snapshots a message instructing storage nodes 114 to back up data by sending pages of the snapshot needing back up to the volume owner. The volume owner may also communicate metadata associated with the pages (e.g., urgent flags). In response, the storage nodes 114 may begin backing up data as described in greater detail below with respect to method 400. After completion of step 310, method 300 may end.

Although FIG. 3 discloses a particular number of steps to be taken with respect to method 300, it may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using system 100, components thereof or any other system operable to implement method 300. In certain embodiments, method 300 may be implemented partially or fully in software and/or firmware (e.g., back up agent 116) embodied in computer-readable media.

FIG. 4 illustrates a flow chart of an example method 400 of execution of a storage node 114 having a storage resource 112 which is part of a logical unit having stored thereon a portion of a snapshot to be backed up during a back up operation, in accordance with embodiments of the present disclosure. According to certain embodiments, method 400 may begin at step 402. As noted above, teachings of the present disclosure may be implemented in a variety of configurations of system 100. As such, the preferred initialization point for method 400 and the order of the steps comprising method 400 may depend on the implementation chosen.

At step 402, back up agent 116 of a given storage node 114 may receive from a volume owner an instruction to back up a snapshot. At step 404, back up agent 116 may determine which pages of the snapshot reside on the given storage node 114. At step 406, if an urgent flag is set for a snapshot, back up agent 116 may mark all pages of such snapshot with an urgent bit or other flag.

At step 408, back up agent 116 may spawn a number of threads and divide the pages of the snapshot among the threads, wherein pages flagged with the urgent flag may be given priority of execution in such threads.

As threads execute, back up agent 116 may, in a loop, monitor the I/O workload in its storage node 114 and predict the I/O workload for host information handling system 102 and dynamically adjust the number of threads of the storage node 114 for backing up pages. For example, for periods of low host information handling system 102 I/O, back up agent 116 may increase thread count, and reduce thread count during periods of high host I/O. Back up agent 116 may also dynamically allocate pages among the threads as the number of threads varies.

In addition or alternatively, as threads execute, back up agent 116 may monitor the health of storage resources 112 on its associated storage node 114. If the health of a storage resource 112 indicates a potential failure, back up agent 116 may determine which snapshots may be likely to become inaccessible due to storage resource failure. In some embodiments, such determination may also be made based on RAID level. Such pages may be marked with a critical flag. During execution, threads may prioritize pages with critical flags over those without critical flags.

Although FIG. 4 discloses a particular number of steps to be taken with respect to method 400, it may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using system 100, components thereof or any other system operable to implement method 400. In certain embodiments, method 400 may be implemented partially or fully in software and/or firmware (e.g., back up agent 116) embodied in computer-readable media.

During execution, each thread instantiated by a back up agent 116 may determine, for each page, whether such page is marked with an urgent flag or critical bit. If marked with an urgent or critical flag, and the page is not in an I/O cache for a storage resource 112, back up agent 116 may, if such functionality is supported (e.g., SCSI command tag queueing is supported), mark the read request with a head of queue tag and queue it at the head of the queue of a storage resource.

In addition, if a storage node 114 has multiple network ports (e.g., Ethernet ports), a thread may determine a current bandwidth utilization (or load) on each network port. If such storage node 114 is not the volume owner of the snapshot to which the page belongs, then the read page may be sent to the volume owner through the network port having the least utilization/congestion. Otherwise, if the storage node 114 is the volume owner of the snapshot to which the page belongs, the page may be communicated via a network port bound to the I/O session between the volume owner and host information handling system 102. When communicating data from storage nodes 114, the storage nodes may also send metadata regarding the page along with the page.

Advantageously, using the methods and systems discussed herein, a back up application 118 need not issue any reads. All it must do is inform an intelligent back up agent 116 on a controller 115 about the back up operation, and then wait for the data. The complete logic for performing back ups resides on controllers 115, and all controllers 115 participate in back up.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An information handling system comprising:
a processor; and
a program of executable instructions embodied in non-transitory computer-readable media accessible to the processor, and configured to, when read and executed by the processor:
communicate to a volume owner of a logical storage unit storing a snapshot to be backed up, an instruction other than an input/output read instruction for backing up the snapshot, wherein the volume owner is one of a plurality of storage nodes in a scale-out storage area network architecture communicatively coupled to the information handling system;
responsive to the instruction, receive from the volume owner pages of data associated with the snapshot and metadata associated with the pages;
from the metadata, form back up metadata for each page;
write the pages to a back up device communicatively coupled to the information handling system; and
upload the back up metadata to a metadata server.

2. The information handling system of claim 1, wherein the metadata for each particular page comprises at least one of a snapshot identifier, a logical block address for the particular page, and a variable indicating an urgency of back up for each snapshot.

3. The information handling system of claim 1, wherein the back up metadata comprises a back up device identifier and an offset.

4. The information handling system of claim 1, wherein the program of executable instructions further causes the processor to:
communicate to a leader of the plurality of storage nodes requesting an identity of the volume owner; and
in response, receive the identity of the volume owner.

5. The information handling system of claim 1, wherein the instruction comprises a list of snapshots stored on logical storage units owned by the volume owner.

6. A storage node comprising:
a plurality of physical storage resources;
a controller; and
a program of executable instructions embodied in non-transitory computer-readable media accessible to the controller, and configured to, when read and executed by the controller:
receive from an information handling system a list of snapshots associated with logical units owned by the storage node;
determine which snapshots to back up in full and which snapshots to back up incrementally as deltas to previous back ups;
determine which storage nodes of a scale-out storage area network architecture are communicatively coupled to the information handling system, wherein the storage node is a member of the scale-out storage area network architecture; and
communicate to each storage node having pages of snapshots to be backed up a message instructing the storage nodes other than the storage node to send pages of snapshots needing back up to the storage node.

7. The storage node of claim 6, wherein the program of executable instructions further causes the processor to receive pages of the snapshots from the storage nodes other than the storage node.

8. The storage node of claim 7, wherein the program of instructions further causes the processor to communicate pages of the snapshots from the storage nodes other than the storage node to the information handling system.

9. The storage node of claim 8, wherein the program of instructions further causes the processor to communicate pages of the snapshots stored on the storage node to the information handling system.

10. The storage node of claim 7, wherein the program of instructions further causes the processor to receive from the information handling system metadata associated with the list of snapshots.

11. The storage node of claim 10, wherein the metadata comprises a variable indicating an urgency of back up for each snapshot.

12. The storage node of claim 7, wherein the program of instructions further causes the processor to determine, for snapshots requiring incremental back up, the blocks of the snapshots requiring back up.

13. A storage node comprising:
a plurality of physical storage resources;
a controller; and
a program of executable instructions embodied in non-transitory computer-readable media accessible to the controller, and configured to, when read and executed by the controller:
receive from a volume owner storage node an instruction to back up data of a snapshot, wherein the storage node and the volume owner storage node are storage nodes of a scale-out storage area network architecture communicatively coupled to an information handling system;
determine which pages of the snapshot reside on the storage node;
receive from an information handling system a list of snapshots associated with logical units owned by the storage node; and
spawn one or more threads and allocate pages of the snapshot among the threads.

14. The storage node of claim 13, wherein the program of instructions further causes the processor to:
determine from metadata associated with the snapshot whether back up for the snapshot is urgent; and
prioritize execution of threads to which pages of the snapshot are allocated if back up for the snapshot is urgent.

15. The storage node of claim 13, wherein the program of instructions further causes the processor to:
determine whether a page of the snapshot is stored on a storage resource having a health status indicating potential failure of the storage resource; and
prioritize execution of threads to the page as allocated if the health status indicates potential failure of the storage resource.

16. The storage node of claim 13, wherein the program of instructions further causes the processor to:
monitor an input/output workload for the information handling system; and
dynamically adjust the number of threads based on the input/output workload.

17. The storage node of claim 16, wherein the program of instructions further causes the processor to re-allocate pages among the threads as the number of threads varies.
